(19) United States
(12) Patent Application Publication
(10) Pub. No.: US 2019/0380514 A1
(43) Pub. Date: Dec. 19, 2019

(54) THREADED PUSH PIN PICTURE HANGER

(71) Applicant: Charles Antonio Kaplan, Scarsdale, NY (US)

(72) Inventor: Charles Antonio Kaplan, Scarsdale, NY (US)

(21) Appl. No.: 16/446,036

(22) Filed: Jun. 19, 2019

Related U.S. Application Data
(60) Provisional application No. 62/686,735, filed on Jun. 19, 2018.

(51) Int. Cl. A47G 1/20; F16B 23/00

(52) U.S. Cl. CPC A47G 1/20; F16B 23/0023

(57) ABSTRACT

A picture hanger includes a base having a front face and a rear end. An elongated shaft protrudes from the front face along a longitudinal axis. The elongated shaft includes a pointed end and male threads along a length. A head extends from the rear end of the base. A channel is defined between the head and the base.

### CROSS-REFERENCE TO RELATED APPLICATION

This application claims the benefit of priority of U.S. provisional application No. 62/686,735, filed Jun. 19, 2018, the contents of which are herein incorporated by reference.

### BACKGROUND OF THE INVENTION

The present invention relates to picture hangers and, more particularly, to a threaded push pin picture hanger.

Hanging pictures typically involves pressing push tacks or hammering nails into drywall and hanging the picture from the tacks and nails. Push tacks are easy to install but do not hold very much weight. If the picture is too heavy, the hole may widen. In some cases, the tack may give and the picture may fall off of the drywall. Nails hold more weight than push tacks, but must be installed using a hammer.

As can be seen, there is a need for a device that is as easy as a push tack to install but holds better in drywall.

### SUMMARY OF THE INVENTION

In one aspect of the present invention, a picture hanger comprises: a base comprising a front face and a rear end; an elongated shaft protruding from the front face along a longitudinal axis, wherein the elongated shaft comprises a pointed end and male threads along a length; and a head extending from the rear end of the base, wherein a channel is defined between the head and the base.

In another aspect of the present invention, a method of hanging a picture comprises steps of: providing a picture hanger comprising: a base comprising a front face and a rear end; an elongated shaft protruding from the front face along a longitudinal axis, wherein the elongated shaft comprises a pointed end and male threads along a length; a head extending from the rear end of the base, wherein a channel is defined between the head and the base; pressing the pointed end into drywall; rotating the base in a clockwise direction, thereby screwing the elongated shaft into the drywall; and hanging a picture from the channel.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention, shown in use;

FIG. 2 is front perspective view of an embodiment of the present invention;

FIG. 3 is a rear perspective view of an embodiment of the present invention;

FIG. 4 is a section view of the present invention taken along line 4-4 in FIG. 2;

FIG. 5 is a perspective view of an embodiment of the present invention, illustrating installation;

FIG. 6 is a perspective view of an embodiment of the present invention, illustrating installation; and

FIG. 7 is a section view of the present invention taken along line 7-7 in FIG. 6.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a push and turn picture hanger. Broadly, the present invention is a fastener which combines the characteristics of both a screw and a tack and does not require the use of a tool for installation. The present invention is as easy to use as a push pin and has the holding strength of a wood screw. To use it, a user simply pushes the fastener into the wall and manually twists. The fastener can be used to hang pictures, artwork, and the like.

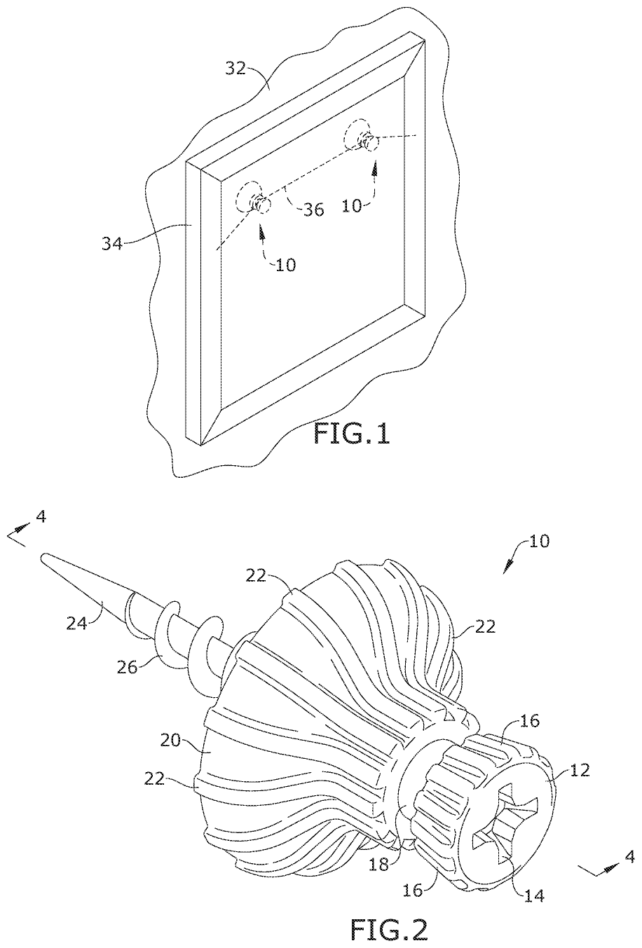

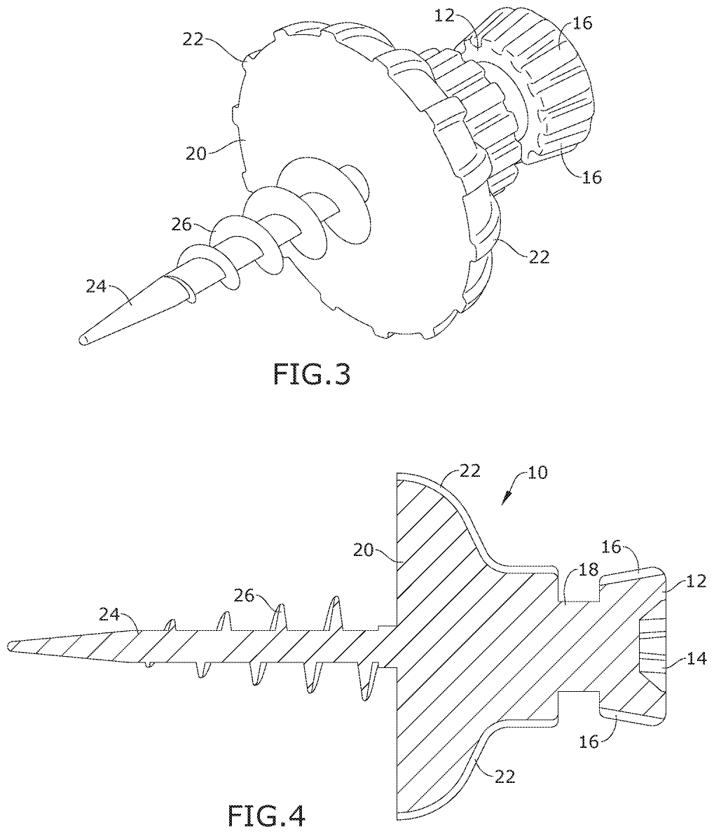

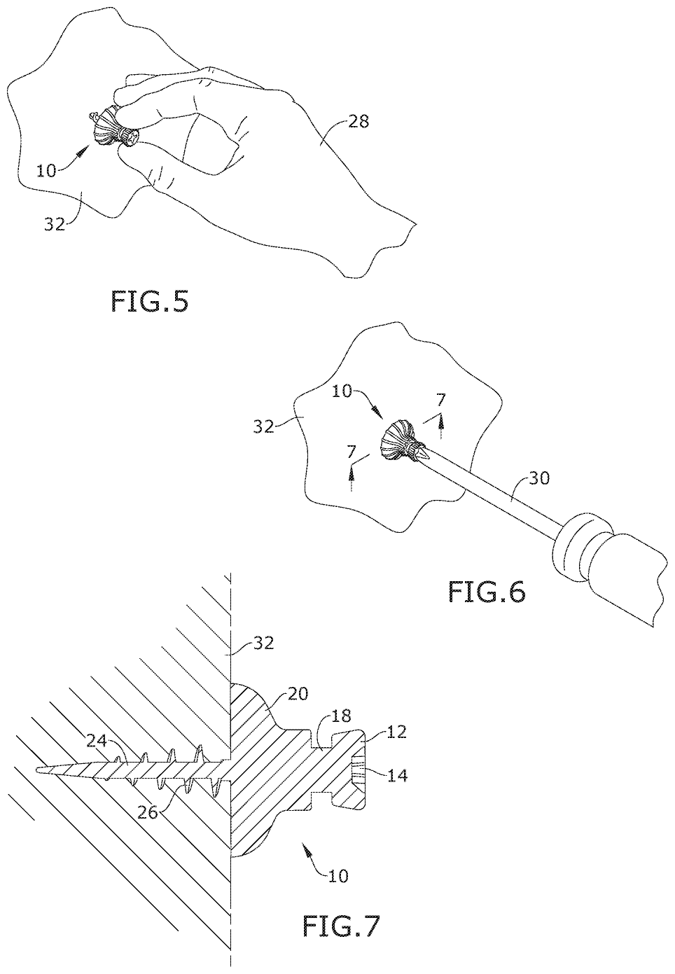

Referring to FIGS. 1 through 7, a picture hanger 10 includes a base 20 having a front face and a rear end. An elongated shaft 24 protrudes from the front face along a longitudinal axis. The elongated shaft 24 includes a pointed end and male threads 26 along a length. A head 12 extends from the rear end of the base 20. A channel 18 is defined between the head 12 and the base 20. The channel 18 may be annular.

The elongated shaft 24 includes a needle-sharp point to puncture drywall 32. The shaft 24 may be made of stainless steel, another metal, or a strong polymer. In certain embodiments, the height of the male threads 26 taper from the base 20 to the pointed end. The pointed end penetrates the drywall and the male threads 26 are used to screw and anchor the present invention into the drywall 32.

The base 20 and the head 12 may be made of a strong polymer or metal. In certain embodiments, the longitudinal axis runs through a center of the base 20 and the head 12. The head 12 may include a screwdriver slot 14 to allow a user 28 to use a screwdriver 30 to drive the elongated shaft 24 into the drywall 32.

The base 20 of the present invention may include a dome shape and the front face is substantially flat. The wider flat front face of the base 20 provides greater mounting stability due to a larger surface contact.

The base 20 and the head 12 may include a finger grip that allows the user 28 to grip the picture hanger 20 and twist the picture hanger 20 into the drywall 32. The finger grip may include ridges 22 protruding from an outer surface of the base 20 and ridges 16 protruding from the outer surface of the head 12. The ridges 16, 22 may run in a same direction as the longitudinal axis.

A method of hanging a picture 34 may include the following steps. Provide the picture hanger 10 described above. Press the pointed end of the elongated shaft 24 into the drywall 32. Rotate the base 20 in a clockwise direction, thereby screwing the elongated shaft 24 into the drywall 32. Hang the picture 34 from the channel 18. A hanger wire 36 may be used to hang from the channel 18. For harder surfaces, the finger grip/head 12 has a screwdriver slot 14 to drive the picture hanger 10 using a screw driver 30 for additional drive force.

In certain embodiments, the elongated shaft 24 is set inside the base 20 using a plastic injection mold process, heat insertion, or other suitable process. In certain embodiments, the manufacturing process sets one item into the other by dipping and cooling to hardening/fusing and securing the items together.

It is understood that the sizes, styles, and materials for the component(s), and the process used to manufacture the component(s) may vary. It is understood, that the foregoing relates to exemplary embodiments of the invention and that modifications may be made without departing from the spirit and scope of the invention as set forth in the following claims.

What is claimed is:

1. A picture hanger comprising:
a base comprising a front face and a rear end;
an elongated shaft protruding from the front face along a longitudinal axis, wherein the elongated shaft comprises a pointed end and male threads along a length; and
a head extending from the rear end of the base, wherein
a channel is defined between the head and the base.

2. The picture hanger of claim 1, wherein a height of the male threads taper from the base to the pointed end.

3. The picture hanger of claim 1, wherein the longitudinal axis runs through a center of the base and the head.

4. The picture hanger of claim 1, wherein the head comprises a screwdriver slot.

5. The picture hanger of claim 1, wherein the base comprises a dome shape and the front face is substantially flat.

6. The picture hanger of claim 1, further comprising ridges protruding from an outer surface of the base and running in a same direction as the longitudinal axis.

7. The picture hanger of claim 1, wherein the head comprises a plurality of ridges protruding from an outer surface and running in a same direction as the longitudinal axis.

8. The picture hanger of claim 1, wherein the channel is annular.

9. A method of hanging a picture comprising steps of:
providing a picture hanger comprising:
a base comprising a front face and a rear end;
an elongated shaft protruding from the front face along a longitudinal axis, wherein the elongated shaft comprises a pointed end and male threads along a length; and
a head extending from the rear end of the base, wherein
a channel is defined between the head and the base;
pressing the pointed end into drywall;
rotating the base in a clockwise direction, thereby screwing the elongated shaft into the drywall; and
hanging a picture from the channel.

10. The method of claim 9, wherein a height of the male threads taper from the base to the pointed end.
